(19) United States
(12) Patent Application Publication
(10) Pub. No.: US 2006/0279560 A1
(43) Pub. Date: Dec. 14, 2006

(54) Stylus and Retainer Card Combination

(75) Inventor: Thomas Patrick Walsh, Novato, CA (US)

Correspondence Address: THOMAS PATRICK WALSH, 32 MANZANO COURT, NOVATO, CA, 94945, US

(73) Assignee: Thomas Patrick Walsh, Novato, CA (US)

(21) Appl. No.: 11/160,132

(22) Filed: Jun. 10, 2005

(51) Int. Cl. G09G 5/00

(52) U.S. Cl. 345/179

(57) ABSTRACT

A stylus and card combination is provided wherein a convenient size stylus carrying card has at least one recess, or a pair of recesses for a stylus, a stylus in each recess, and structure separably retaining the stylus in its recess. The stylus may be hingedly attached to the card and adapted to be swung into and out of the plane of the card. Alternatively, each stylus may be retained in the card by breakaway means.

The present invention relates to stylus, and is more particularly concerned with a novel stylus and retainer card combination.

Styluses, for use with PDA's, and the like, which are virtually universally adapted for PDA's, are generally supplied loosely or in side compartments on the PDA's. This is true for original issue styluses, duplicate stylus sets and replacement styluses.

Carrying of duplicate styluses generally presents a problem. Loose styluses are extremely inconvenient to carry or store for spare replacement use. Carrying loose duplicate styluses in a wallet, purse or garment pocket has obvious limitations and is generally inconvenient.

An important object of the present invention is to provide new and improved means for handling styluses conveniently and in a manner readily adapted for wallet, purse and pocket storage, and especially suitable for carrying of replacement duplicate styluses.

Pursuant to the present invention, there is provided a new and improved stylus and card combination, comprising a stylus carrying card, at least one stylus recess in the card, a stylus in the recess, and means separably retaining the stylus in the recess.

Other objects, features and advantages of the present invention will be readily apparent from the following description of preferred embodiments thereof, taken in conjunction with the accompanying drawings, although variations and modifications may be effected without departing from the spirit and scope of the novel concepts of the disclosure, and in which:

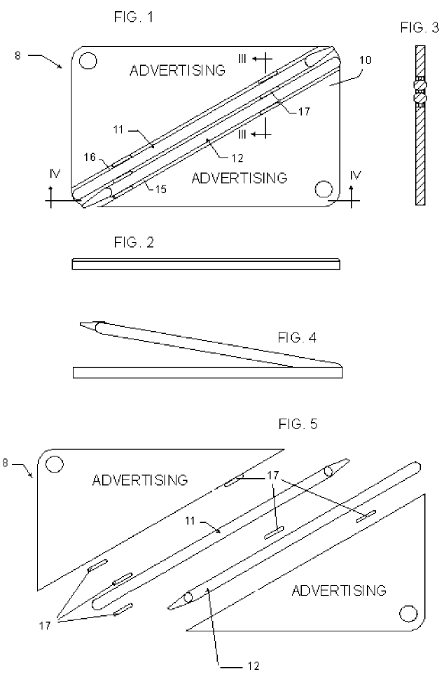

FIG. 1 is a plan view of a stylus and card combination embodying the present invention;

FIG. 2 is a side elevational view of the article of FIG. 1;

FIG. 3 is a fragmentary sectional view taken substantially along the line III--III in FIG. 1;

FIG. 4 is a longitudinal sectional detail view taken substantially along the line IV--IV in FIG. 1, but showing the stylus in a raised position;

FIG. 5 is a view similar to FIG. 1 but showing how the styluses are removable from the card.

In one preferred form of the present invention, a stylus and retainer card combination 8 comprises a convenient, preferably generally wallet (e.g. credit card) size card 10 carrying at least one, and as shown a pair of styluses 11 and 12.

The card 10 and the styluses 11 and 12 may be made from the same material, such as a glass filled polycarbonate synthetic resin (plastic material) which may be injection molded and affords adequate stiffness without brittleness in both the card 10 and the styluses 11 and 12. As depicted in FIGS. 3-4, the card 10 may be of a relatively thin section such as that commonly present in plastic credit cards. On the other hand, the styluses 11 and 12 may be of a thicker section, such as about twice the card thickness, to withstand twisting stresses in use.

In a desirable arrangement, the styluses 11 and 12 are located in the plane of the card 10, in respective stylus recesses or slots there being a slot 15 for the stylus 18 and a slot 16 for the stylus 19. Each of the slots is preferably of a size complementary to its stylus including the head of the stylus and the stylus shank, and with a sufficient clearance or tolerance relative to the edges of the styluses to permit the styluses to be easily displaced from the slots as desired.

Each of the styluses 11 and 12 may be separated from the card 10 in a manner permitting the stylus to be detached from the plane of the card when desired. For this purpose, the stylus 11 has integral tab connections 17 attaching it to the card 10. Similarly, the stylus 12 is connected to the card 10 by means of tab connections 17. This permits the card/stylus combination to be conveniently injection molded, wherein the slots 15 and 16 are formed in the card 10, and the stylus 11 and 12 are adapted to be molded in generally displaced relation to the card but connected thereto by the tab connections 17.

When it is desired to use a stylus 11 or 12, it is easily pushed out of its slot by applying pressure against a face of the stylus to snap it out of engagement with its card 10.

In FIG. 5, the stylus and card combination 8 has, similarly as the combination 8 in FIG. 1 a card 10 and styluses 11 and 12. The styluses 11 and 12 are fabricated integrally attached to the card 10 within complimentary recesses by means of breakaway tabs 17 which integrally connect the styluses to the card. There may be at least one of the breakaway tabs 17 connecting the tip of each stylus shank to the card, and a plurality of the tabs connecting the head of each of the stylus blanks, to maintain the styluses in a stable relation in the card until it is desired to remove one of the styluses for use. The manner in which the styluses are detached from the card 10 is demonstrated in FIG. 5 wherein separation of the styluses are shown.

It will be appreciated that the styluses 11 and 12 may be supplied originally as generic styluses. The styluses 11 and 12 may be molded plastic, e.g. glass filled polycarbonate, or conventional aluminum or other metal styluses.

From the foregoing, it will be apparent that the present invention provides a novel stylus and retainer card combination well adapted for spare stylus storage and use or original issue stylus storage and use. The combination facilitates handling and storage of the styluses as for example for wallet, key chain, handbag, purse or pocket storage and retrieval. The flat structural relationship of the combination assures maximum utilization of minimum storage space, especially for stylus sets. Any of the stylus and retainer card combinations described, or modifications thereof are adapted to be produced economically and supplied at low cost.

Although PDA styluses have been indicated in the illustrated forms of the invention, it will be appreciated that other types of PDA styluses may be similarly handled or adapted to operate PDA's.

It will be understood that variations and modifications may be effected without departing from the spirit and scope of the novel concepts of this invention.

What is claimed is:

1. A stylus and card combination, comprising:
a stylus carrying generally rectangular wallet size plastic card of credit card-type thickness and dimensions and having opposite faces;
at least one stylus recess in said card extending entirely through the thickness of the card;
a stylus of greater thickness than the card in said recess consisting of the same plastic material as said card;
said stylus having an edge thereabout, and said recess being defined by an edge substantially surrounding said stylus edge;
and means on an area of said stylus edge and on a corresponding area of said recess edge for separably retaining the stylus in said recess and with the stylus having a face portion which is elevated from the plane of the adjacent card face.

2. A combination according to claim 1, wherein said recess comprises a stylus slot within the plane of said card, and said separably retaining means comprising a hinge formed from the same material as the card and the stylus and integrally connecting a stylus head of the stylus to said corresponding area of said recess edge of the card and adapting the stylus to be swung into and out of the plane of the card.

3. A combination according to claim 1, wherein said means separably retaining the stylus comprises breakaway structure.

4. A combination according to claim 1, wherein said means separably retaining the stylus comprises yieldable detent structure.

5. A combination according to claim 4, wherein said means separably retaining the stylus further includes a hinge connecting the stylus to the card so that the stylus can be swung into and out of said recess while remaining attached to the card.

6. A combination according to claim 1, wherein said card and said stylus are fabricated in one piece from a plastic material.

7. A combination according to claim 1, wherein said card is fabricated from a plastic material, and said stylus is fabricated from metal.

8. A combination according to claim 1, wherein the card includes a second stylus recess, and a second stylus, and means for separably retaining the second stylus in the second recess, so that the card is adapted for carrying a set of styluses.

9. A combination according to claim 1, wherein said stylus has a further face portion opposite to said elevated face portion which is also elevated from the card face which is adjacent to said further face portion.

10. A stylus card combination, comprising:
a stylus-shaped recess slot in the plane of the card;
a stylus in the recess slot consisting of the same material as said card so that said stylus and card can be simultaneously formed;
integral hinge means consisting of the same material as said stylus and said card connecting an edge of a head end of the stylus to an edge of the card in said slot for permitting the stylus to be swung out from and swung back into the plane of the card without severing said hinge means; and
means formed of the same material as said stylus, said card and said hinge means for at least initially retaining the stylus separably in said recess slot against being swung out of said recess.
